(19) United States
(12) Patent Application Publication
(10) Pub. No.: US 2015/0376077 A1
(43) Pub. Date: Dec. 31, 2015

(54) POLYMER COATED FERTILIZER COMPOSITIONS AND METHODS OF MAKING THEREOF

(71) Applicant: Koch Biological Solutions, LLC, Wichita, KS (US)

(72) Inventors: DOUGLAS BARR, Decatur, GA (US); Stanley Freeman, Decatur, GA (US); Sabesh Kanagalingam, Decatur, GA (US)

(21) Appl. No.: 14/716,434

(22) Filed: May 19, 2015

Related U.S. Application Data
(60) Provisional application No. 62/018,297, filed on Jun. 27, 2014.

(51) Int. Cl. C05G 3/00; C05C 9/00

(52) U.S. Cl. CPC C05G 3/0029; C05C 9/005; C05G 3/0035

(57) ABSTRACT

The present invention provides a controlled release, solid fertilizer composition comprising a water-soluble central substrate and at least three layers of a water insoluble coating formed by reacting a polyisocyanate and a polyol and further comprising a coating of an organic wax. The present invention provides a better release profile in relation to the amount of coating materials applied than known fertilizers. Preparation systems and processes are also provided.

This application claims the benefit of co-pending U.S. Provisional Application No. 62/018,297 filed Jun. 27, 2014, the entire contents of which are hereby incorporated by reference.

### FIELD OF INVENTION

This invention relates to a coated, controlled release solid fertilizer composition and an improved system and process for uniformly coating particulate granules with a coating material.

### BACKGROUND OF THE INVENTION

Controlled release fertilizers have a number of advantages including decreasing the phytotoxicity of fertilizer components to plants and decreasing amount and number of times fertilizers have to be applied by presenting more efficient delivery to plants by minimizing leaching. Ideally the fertilizer releases nutrients at a rate equal to its uptake by plants. Improved release control has been achieved primarily with nitrogen in the form of urea, by reacting it with aldehydes to form insoluble products such as ureaform, by using it in conjunction with urease or nitrification inhibitors, or physically coating the fertilizer with sulfur, wax, plastic or polymer coatings which are slowly broken down by erosion, internal vapor pressure, microbes, or hydrolysis to make the contained nutrients available.

Commercial solid nitrogen-based fertilizers such as urea and ammonium nitrate are produced and marketed in several different forms, i.e., granular, pelletized, compounded, pastilled and prilled fertilizers. They may also include other organic or inorganic substances which may act as plant nutrients such as phosphorus, potassium, calcium, boron, magnesium, zinc, chlorine, etc. and combinations thereof. Examples include Potash or Muriate of Potash, (MOP) which refers to potassium containing compositions which may include potassium chloride, potassium carbonate, potassium hydroxide, potassium chlorate, potassium nitrate, potassium sulfate, potassium permanganate and the like; Sulfate of Potash (SOP), a composition of ca. 50% potassium oxide (K₂O) and 18% sulfur; K-Mag, a potassium, magnesium and sulfur based fertilizer. Common fertilizers are designated as 20-20-5 and the like to designate the relative ratios of particular plant nutrients. Examples include MAP (monoammonium phosphate) 11-52-0 which has 11 units of nitrogen, 52 units of phosphate and 0 units of Potash. In addition, specialized fertilizers may contain optional additives such as herbicides, insecticides, trace elements, iron salts, etc. Examples of controlled-release fertilizers include those disclosed in U.S. Pat. Nos. 3,342,577; 3,475,154; 3,259,482; 3,263,088; 3,264,089; 4,804,403; 4,711,659; 4,772,490; 4,804,403; 4,969,947; 5,374,292, 5,435,821; 5,538,531, 7,018,440; 7,018,441; 7,267,707 and 7,544,736 and U.S. Patent Application Publications 2010/0307211, 2010/0275665, 2010/0233332, 2010/0186470, 2008/010878; 2006/0222735; all of which are incorporated by reference in their entireties.

In addition, to the above-problems, other problems with solid fertilizers include their tendencies to cake and/or form dust. While coating materials can help solve these problems, they can also be expensive and have other environmental problems. The present invention provides further improvements in solid fertilizers that improve their extended release properties i.e., more prolonged, or better timed while requiring less coating material. The present invention also provides an improved system for providing uniform coatings to large quantities fertilizers needed for commercial application.

### BRIEF SUMMARY OF THE INVENTION

One aspect of this invention is to provide a solid fertilizer composition comprising:
(a) at least one plant fertilizer compound in solid form; (b) at least 3 layers of a polyurethane coating which is a reaction product of: i: a polyisocyanate, and ii: a polyol; and (c) a coating comprising a water-insoluble material.

In another aspect this invention provides a process of producing a fertilizer of claim 1 comprising: (a) providing a substrate of plant food compound; (b) optionally prewetting said plant fertilizer compound with a prewetting solution comprising water and a catalyst; (c) rotating said substrate product of step (b); (d) contacting product of step (c) above with a polyisocyanate; and (e) contacting said product of step (d) with a polyol; (f) allowing the polyisocyanate and polyol to react forming a solidified polyurethane coating on said fertilizer particles, (g) repeating step (a) at least 3 times; (h) adding to said product of step (g) an water-insoluble material to produce a water-insoluble coating thereon, and (i) thereafter cooling said coated fertilizer particles to below the melting point of the water-insoluble material.

It is a further aspect of this invention to provide an effective method for increased controlled release coated fertilizer particles with improved handling characteristics while using less overall coating material.

### BRIEF DESCRIPTION OF THE FIGURES

FIG. 1 illustrates the water release rate profile for the controlled release fertilizer material of the present invention.

### DETAILED DESCRIPTION OF THE INVENTION

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the suitable methods and materials are now described.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, agricultural chemistry, and the like, which are within the skill of the art. Such techniques are explained fully in the literature.

The following embodiments are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C. and pressure is in atmospheres. Standard temperature and pressure are defined as 20° C. and 1 atmosphere absolute.

As used in this specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The term “about” as used herein to modify a numerical value indicates a defined range around that value. If “X” were a specified value, “about X” would generally indicate a range of values from 0.95X to 1.05X. Any reference to “about X” specifically denotes at least the values X, 0.95X, 0.96X, 0.97X, 0.98X, 0.99X, 1.01X, 1.02X, 0.03X, 1.04X, and 1.05X. Thus, “about X” is intended to teach and provide written description support for a claim limitation of, e.g., “0.98X.” When the quantity “X” only includes whole-integer values (e.g., “X carbons”), “about X” indicates a range from (X−1) to (X+1). In this case, “about X” as used herein specifically indicates at least the values X, X−1, and X+1. When “about” is applied to the beginning of a numerical range, it applies to both ends of the range. Thus, “from about 0.2 to 2.0%” is equivalent to “from about 0.2% to about 2.0%.” When “about” is applied to the first value of a set of values, it applies to all values in that set. Thus, “about 2, 4, or 7%” is equivalent to “about 2%, about 4%, or about 7%.”

In formulations comprising an “additional,” “further,” or “second” component, the second component as used herein is chemically different from the other components or first component. A “third” component is different from the other, first, and second components, and further enumerated or “additional” components are similarly different.

The term “or” as used herein should in general be construed non-exclusively. For example, an embodiment of “a composition comprising A or B” would typically present an aspect with a composition comprising both A and B. “Or” should, however, be construed to exclude those aspects presented that cannot be combined without contradiction (e.g., a composition that is about 5% by weight or about 10% by weight).

Generally, when a percentage range is taught, it is intended to describe all full or partial percentages in between (i.e., within the bounds of the range). For example, a percentage range of 15 to 25% would also teach inter alia the specific values of 17.36% and 21%. A percentage range of about 13 to 17% would also teach inter alia the specific values of 12.97%, 16%, and 17.1%.

All parts are by weight and all percentages of component are by weight based upon the total weight of the product containing a stated component, unless otherwise stated. When solutions of components are referred to, percentages refer to weight-percentages of the composition including the solvent (e.g., water) unless otherwise indicated.

### Fertilizer Substrate

The solid substrate for the fertilizers of the present invention can be any conventional plant fertilizer normally used for plant nutrition.

The substrate used in the present invention may contain fertilizer ingredients such as nitrogen, phosphorus, potassium, sulfur, silicon, magnesium, calcium, manganese, boron, iron and so on, for supplying nutrients to cultivating crops. Typical examples thereof include nitrogen fertilizer such as urea, ammonium nitrate, ammonium magnesium nitrate, ammonium chloride, ammonium sulfate, ammonium phosphate, sodium nitrate, calcium nitrate, potassium nitrate, lime nitrogen, urea-form (UF), crotonylidene diurea (CDU), isobutylidene diurea (IBDU), guanylurea (GU); phosphate fertilizer such as calcium superphosphate, concentrated superphosphate, fused phosphate, humic acid phosphorus fertilizer, calcined phosphate, calcined conc. phosphate, magnesium superphosphate, ammonium polyphosphate, potassium metaphosphate, calcium metaphosphate, magnesium phosphate, ammonium sulfate phosphate, ammonium potassium nitrate phosphate and ammonium chloride phosphate; potash fertilizer such as potassium chloride, potassium sulfate, potassium sodium sulfate, potassium sulfate magnesia, potassium bicarbonate and potassium potassium phosphate; Muriate of Potash, (MOP) which refers to potassium containing compositions which may include potassium chloride, potassium carbonate, potassium hydroxide, potassium chlorate, potassium nitrate, potassium sulfate, potassium permanganate and the like; Sulfate of Potash (SOP), a composition of ca. 50% potassium oxide (K₂O); silicate fertilizer such as calcium silicate; magnesium fertilizer such as magnesium sulfate and magnesium chloride; calcium fertilizer such as calcium oxide, calcium hydroxide and calcium carbonate; manganese fertilizer such as manganese sulfate, manganese sulfate magnesia and manganese slag; boron fertilizer such as boric acid and borates; and iron fertilizer such as slag; K-Mag, a potassium, magnesium and sulfur based fertilizer. The fertilizer compound is not particularly critical to the instant invention.

In one group of embodiments, urea can include any suitable solid urea source, including but not limited to granulated, prilled, pelletized, pastilled or compounded urea.

In one group of embodiments, fertilizers containing at least one fertilizer ingredient selected from nitrogen (N), phosphorous (P) and potassium (K) are used. Typical examples are urea and NPK type (NP₂O₅K₂O) fertilizers; Potash; Muriate of Potash, (MOP); Sulfate of Potash (SOP), and K-Mag.

NPK type (NP₂O₅K₂O) fertilizers include No. 1 type such as 5-5-7 (hereinafter, the numbers mean weight percentages of NP₂O₅K₂O) and 12-12-16; No. 2 type such as 5-5-5 and 14-14-14; No. 3 type such as 6-6-5 and 8-8-5; No. 4 type such as 4-7-9 and 6-8-11; No. 5 type such as 4-7-7 and 10-20-20; No. 6 type such as 4-7-4 and 6-9-6; No. 7 type such as 6-4-5 and 14-10-13; No. 8 type such as 6-5-5 and 18-11-11; No. 9 type such as 7-6-5 and 14-12-9; No. 10 NP type such as 3-20-0 and 18-35-0; No. 11 NK type such as 16-0-12 and 18-0-16; and No. 12 PK type such as 0-3-14 and 0-15-15.

In one group of embodiments, the compounds comprising the substrate have reactive functionality available at the surface of the substrate for reaction with a coupling agent. Examples of compounds containing NH₂ (amino) functionality include urea, substituted ureas including ureaform and alkylurea; biurets, guanidine, melamine, amino acids, proteins, methylolureas, ethanolamines, and ammonia compounds; compounds having OH (hydroxyl) functionality and plant food value, such as the nitrogen-containing polyols, and the plant food materials monoammonium phosphate, diammonium phosphate, ammonium polyphosphate, monopotassium phosphate, dipotassium phosphate, potassium bicarbonate, ammonium sulfate, potassium bisulfate, those containing carboxyl functionalities such as potassium formate, potassium acetate and potassium diacetate, and elemental sulfur.

The term “substituted urea” used herein refers to compounds such as RNHCONHR′ formed by the reaction of the NCO group in RNCO with the NH₂ group of R′NH₂. The substituted ureas are solids with limited water solubility. They are generally too soluble to protect the substrate of plant food from dissolution by water. These ureas, however, form a very strong physical and chemical bond between the substrate and the water-insoluble coating layer. The reason is unknown, but it is thought to be related to the chemical similarity of the substituted ureas to both the NH₂ groups of the substrate and the isocyanate-based polymers in the sealing layer.

In one group of embodiments, the substrate contains at least about 10 percent reactive functional groups, such as nucleophilic groups, to provide the reaction sites for chemically bonding to a coupling material. In another group of embodiments, the substrate contains at least 25 percent reactive functional groups. In another group of embodiments, the substrate contains 25 to 60 percent reactive functional groups.

The particle diameter of the solid fertilizer core used in the present invention is not specifically limited, but can be within a range such that it can be sized through standard mesh screens, for example a −6+14 U.S. standard mesh screen.

### Polymer Components

The polymer components used in the present invention can be any that form a urethane polymer, epoxy polymer, alkyd polymer, unsaturated polyester polymer, phenol polymer, urea polymer, melamine polymer, silicone polymer and so on. In one group of embodiments, urethane polymer is used. The polymer of the first polymer layer and the polymer of a subsequent polymer layer can be the same or different. In one group of embodiments, the same polymer components are used.

Urethane polymer can be produced by the reaction of a coupling agent, such as a polyisocyanate with another monomeric material, such as a polyol to make cross-linkage.

### Coupling Agents

In one group of embodiments, the coupling agent is an isocyanate or “polyisocyanate”. It is understood that the term “polyisocyanate” is used to define aliphatic, aromatic, and aliphatic aromatic polyisocyanate compounds generally known as polyisocyanates. These compounds contain two or more NCO groups available for reaction, and are widely used in the production of polyurethane polymers. Examples of the polyisocyanate include toluene diisocyanate (TDI). diphenylmethane diiusocyanate (MDI), naphthalene diilsocyanate, tolidine diisocyanate, hexamethylene diisocyanate, isophorone diiusocyanate, xylylene diilsocyanate and mixture thereof. Among them, MDI, TDI and the oligomers derived from MDI or TDI (e.g. polymeric MDI (pMDI), polymeric TDI) may be used. The polyisocyanate may be a mixture of two or more polyisocyanate compounds.

The amount of coupling agent utilized to form the coating is not critical. It was found that the coupling agent may be between 0.03 and 10 percent of the total fertilizer particle. Larger amounts are difficult to apply in a practical manner and are costly.

To achieve a chemical bond between the first layer of coating and the substrate of soluble fertilizer, the coupling agent, such as the polyfunctional isocyanate used in the composition, is usually fluid at the time of reaction and may have a kinematic viscosity lower than 200 centipoise at 25° C. or between 60 and 120; and that it be chemically reactive at relatively low temperatures, i.e., at temperatures below about 160° C., or in the range of 30° C. to 110° C., or in the range of 90° C. to 100° C. Coupling agents most effective are those having a reactive functional group content between 10 and 60 percent, or between 25 and 45 percent.

### Monomers

In one group of embodiments the monomeric compound used is a polyol. The term “polyol” is used to define organic compounds containing two or more OH groups located on an aliphatic or aromatic carbon skeleton. Because of the nucleophilic nature of the OH groups, these compounds may be readily reacted and polymerized with the electrophilic polyfunctional isocyanates. The polyols used in the instant invention may be substantially anhydrous. In one group of embodiments the organic polyol of the water-insoluble sealing layer was selected from aliphatic, aromatic, and aliphatic aromatic polyether and polyester compounds, or their mixtures, which terminate in two or more OH groups. These polyols may be simple polyethers, such as those produced by the reaction and polymerization of ethylene oxide with ethylene glycol, or complicated ones involving reactions and polymerizations of aromatic groups, and amine terminating groups. The polyesters may be simple ones, such as those formed by the reactions and polymerization of ethylene glycol with terephthalic acid or complicated ones containing additional monomers. Examples of the polyol include polyether polyols prepared by condensation polymerization of aliphatic alcohol (e.g. propylene glycol, trimethylolpropane) with ethylene oxide or propylene oxide using an amino alcohol or amine as an initiator, polytetramethylene ether glycol prepared by polymerization of tetrahydrofuran; polyester polyols obtained by the reaction of a polyether polyol, carboxylic acid and polyhydric alcohol or natural fat or oil having hydroxy groups such as isano oil and castor oil. Further examples of polyols include those disclosed in U.S. Patent Application Publication No. 2013/0042659, which is incorporated by reference in its entirety. Further, the polyol may be a mixture of two or more polyol compounds.

In one embodiment, the polyols contain less than 0.1 percent water and exhibit hydroxyl numbers between 200 and 400.

The coupling agent may react at the surface of the substrate to form what can be considered part of a first layer coating which surrounds and chemically bonds to the substrate. The coupling agent may then react with a monomer compound to form a polymer coating. The coupling agent can be any monomeric-type material having at least two functional groups available for coupling. In this context, monomer-type component or monomeric-type material includes those materials having the necessary functionality and includes compounds, low molecular weight polymers, and the like. The available functionality may be selected so that it will react with the reactive functionality, such as a nucleophilic group on the fertilizer substrate and also with the functionality of the monomer component providing the polymer coating. Compounds which can be used, depending upon the functionality on the water-soluble mass and the component forming the water-insoluble coating, can be a polyfunctional isocyanate, such as diphenylmethane diisocyanate; a polycarboxylic acid compound, such as terephthalic acid, and adipic acid, or an amino-substituted carboxyl group; an anhydride of a polycarboxylic acid, such as maleic anhydride; an alkylated polycarboxylic acid, such as methyl terephthalate; and the like.

In the event the substrate contains amino functionality, and the coupling agent may be a polyisocyanate, the base coating consists of substituted ureas formed by reacting a molecular excess of the polyfunctional isocyanate with the NH₂ groups of the substrate. The chemical bond is formed by the penetration of the isocyanate at and near the surface of the substrate to react with the NH₂ groups available there. A molecular excess of the coupling agent such as the isocyanate means that sufficient functionality, such as NCO (isocyanate) groups, are present to react with all the reactive groups available at the surface of the substrate, and to provide sufficient unreacted groups to form a chemical bond with the sealing layer.

The NCO/OH equivalent ratio of the used polyisocyanate and polyol can be in the range of 0.9 to 1.8. The uncured polymer may be in any form of solvent-free type, solution and aqueous emulsion, but may be in the form of solvent-free type and being liquid at the processing temperature.

### Optional Catalyst

The uncured urethane polymer in the present invention is a mixture of the polyisocyanate compound, the polyol compound and optionally a curing catalyst, and is obtained by mixing them without any reaction or by previously reacting a portion of them to such a degree that cross-linking does not occur. It may be useful to add a catalyst in order to accelerate the curing reaction. Examples of the curing catalyst of the urethane polymer include amines, alkanolamines, melamine, and alkylamines, such as triethanolamine (TEOA), triethylenediamine, N-methylmorpholine, N,N-dimethylmorphiline, diazabicycloundecene, imidazole, ethylmethylimidazole, diazabicyclooctane and 2,4,6-tris (dimethylaminomethyl)phenol; ammonia derivatives such as urea; alkali compounds such as sodium hydroxide and potassium hydroxide; and organotin compounds such as dibutyltin laurate, dibutyltin maleate; tin octoate, and iron octoate. In one group of embodiments, an amine catalyst may be used. In another group of embodiments, triethanolamine is used. These catalysts may be used as they are, or in the form of an aqueous solution or suspension. A solid catalyst may be used in the form of a ground powder. The amount of the catalyst is usually 0.05 to 6 parts by weight based on 100 parts by weight of the total amount of the polyisocyanate compound and the polyol compound, when the catalyst is used.

The present fertilizer can be produced by coating a solid fertilizer with at least three polymer layers and at least one water-insoluble layer in any combination. In one group of embodiments, the solid fertilizer is coated with a polymer layer (first polymer layer), then a water-insoluble layer (first water-insoluble layer), then another polymer layer (second polymer layer); then another water insoluble layer (second water-insoluble layer); and then another polymer layer (third polymer layer); then another water insoluble layer (third water-insoluble layer); from inner to outer layers. In one group of embodiments, the solid fertilizer is coated with a polymer layer (first polymer layer), then another polymer layer (second polymer layer); and then another polymer layer (third polymer layer); then a water insoluble layer (first water-insoluble layer); from inner to outer layers. In one group of embodiments, the solid fertilizer is coated with a polymer layer (first polymer layer), then a water-insoluble layer (first water-insoluble layer), then another polymer layer (second polymer layer); then another water insoluble layer (second water-insoluble layer); then another polymer layer (third polymer layer); and then another water insoluble layer (third water-insoluble layer); and then another polymer layer (third polymer layer); from inner to outer layers. In one group of embodiments, the solid fertilizer is coated with a polymer layer (first polymer layer), then another polymer layer (second polymer layer); and then another polymer layer (third polymer layer); then another water insoluble layer (third water-insoluble layer); and then another polymer layer (fourth polymer layer); from inner to outer layers.

### Water Insoluble Material

The water insoluble material used one of the layers in the present invention should be solid at ambient temperatures. Its melting point or softening point is usually 40 to 120° C., or 50 to 100° C., or 60 to 90° C. The water insoluble material can be a wax, fatty acid, fatty acid salt, fatty acid ester, higher alcohol, silicone and mixtures thereof.

Examples of waxes include insect and animal waxes such as beeswax; vegetable waxes such as candelilla, carnauba, japan wax, ouricury waxes, Douglas-fir bark wax, rice-bran wax, jojoba, castor wax, and bayberry wax; mineral waxes such as montan wax, peat waxes, ozokerite and ceresin waxes, and petroleum waxes (e.g. paraffin wax, microcrystalline wax, semicrystalline wax); and synthetic waxes such as polyethylene wax, Fischer-Tropsch waxes, copolymer waxes of ethylene, propylene and/or acrylic acid, and mixture of petroleum wax with ethylene-vinyl acetate copolymer. In one group of embodiments, petroleum waxes and/or synthetic waxes are used.

The amount of the water-insoluble material layer is usually 0.1 to 1.0 parts, or 0.2 to 0.5 part by weight based on 100 parts by weight of the granular fertilizer core. Further, the amount of the water-insoluble layer to the polymer layer is 1:100 to 10:100 or 2:100 to 5:100.

In one embodiment, the fertilizer particle composition of this invention, comprises a substrate of urea a first layer of coating, surrounding and chemically bonded to the substrate, formed by reacting a molecular excess of polymeric diphenylmethane diisocyanate, amounting to between 0.5 and 1.5 percent of the fertilizer particle and containing between 30 and 33 percent NCO, with the NH₂ functional groups from the substrate of urea; a water-insoluble sealing layer surrounding and chemically bonded to the base coating, formed by the reaction and polymerization of the excess polymeric diphenylmethane diisocyanate of the base coating, with an amount polyol to produce an NCO to OH moiety ratio between 1.1 and 1.8, with the polyol containing between 0.1 and 10 percent trialkanolamine and less than 0.1 percent water, and exhibiting a hydroxyl number between 225 and 350; and between 1 and 5 polymer layers of coatings comprising at least one layer of a water-insoluble material.

### Process and System

The first step forming the polymer layer can be carried out by placing the fertilizer in a rotated state; adding the components of the uncured polymer to the fertilizer, and curing thermally. The polyol component may be applied to the substrate of fertilizer prior to, subsequent to or simultaneously with the addition of the first isocyanate component. The amount of the first polymer is usually 1 to 10 parts by weight, or 2 to 5 parts by weight, based on 100 parts by weight of the granular fertilizer core. The first step may be performed by the addition of the uncured polymer, coating and curing once, but the coating of the polymer can be performed at least three or more times. In one group of embodiments, the amount of the uncured polymer is an amount that can form a 1 to 10 μm, or 2 to 5 μm, of the polymer layer in thickness.

The urethane coating is applied to the fertilizer heated to a temperature between about 30° C. and 160° C., or between 80° C. and 120° C., or between 60° C. and 105′ C and holding for a period of time between one and 30 minutes, or between two and ten minutes.

The particles are kept in continuous low shear, low impact, motion relative to each other by mixing apparatus. Suitable tumbling methods include fluid bed, rotating drum, pan pelletizer, and others which can provide a low shear motion. These methods can be operated in series, with one component added in each of the continuous fluid beds, or in parallel.

The temperature and agitation are maintained for a sufficient period to cause the urethane polymer to cure.

The procedures of the addition of the uncured polymer, coating and curing are performed several times for forming a desired numbers of types of layers and thicknesses. In the first step, the curing of the polymer is not necessarily complete curing, but sufficient to make the uncured polymer sufficiently solid that the solid fertilizer particles will not agglomerate or aggregate. The addition of the uncured polymer can be performed by dropping, spraying or the like. The temperature for curing to form the first polymer layer is usually a temperature that makes the solidification time 10 minutes or less, or 5 minutes or less, or 3 minutes or less. The use of a catalyst may make the temperature for curing lower. The catalyst can be added to the uncured polymer, the polyol or added to the mixing of solid fertilizer particles either before or after the addition of the uncured polymer components.

Subsequent steps forming the second and additional polymer layers can be carried out by the same procedure as the first step. Subsequent polymer forming steps may comprise a process of keeping the granules coated with the subsequent polymer layer in the rotated state at the necessary temperature for complete curing. The first polymer and the subsequent polymer layers can be the same or different. In one group of embodiments, the same polymer is used. The amount of the subsequent polymer layers can be the same or less than the first layer. The amount of the subsequent polymer layers is usually 1 to 10 parts by weight based on 100 parts by weight of the solid fertilizer core. The total amount of the first polymer and the second polymer is usually 2 to 5 parts by weight based on 100 parts by weight of the granular fertilizer core.

Additional steps involve forming at least one water-insoluble layer. The forming of a water-soluble layer can be carried out by adding the water-insoluble material to the granules obtained by the first step in a rotated state at the temperature of the melting point or softening point of the water-insoluble material or more; and keeping the granules in a rotated state at the temperature of the melting point or softening point of the water-insoluble material or more for coating uniformly. The water-insoluble layer forming step can also be carried out by keeping the granules in a rotated state at the temperature of the melting point or softening point of the water-insoluble material or more; spraying the water-insoluble material from a spray-nozzle; and placing the granules in a rotated state for coating uniformly.

The level of the water-insoluble layer is applied is from about 0.1% to about 1%, or from about 0.2% to 0.5%, based on the weight of the fertilizer particles.

In one group of embodiments, when the urethane coated particles are free flowing, molten wax is added and heat and agitation continued until the wax has formed a contiguous film on the particles, about 0.5 to 10 minutes. The particles are cooled with agitation to prevent agglomeration until the temperature has reached a level at which the wax coating is non-tacky and the urea particles are free flowing.

The above-mentioned steps, while discrete, are usually performed batchwise or continuously. In a method of placing the granules into the tumbling state, an apparatus is not specifically limited and a known conventional apparatus can be used and examples thereof include rotary pan, rotary drum, fluidized bed, prilling tower and the like. An apparatus with a heating-equipment is suitable more uniform products and processing times.

Though the coated fertilizer of the present invention has at least three polymer coating layers, each of the layers are not necessarily completely discrete. Thus, as the present granular coated fertilizer is usually produced by the above-mentioned steps, a partial interchange of the materials may occur between the adjacent layers. As a result, the water-insoluble material layers may contain some polymer and the polymer layers may contain some water-insoluble materials in an amount given by the partial interchange caused by the above-mentioned steps.

The coated fertilizer of the present invention effectively controls release of the fertilizer for a long time. It has been found that the rate of fertilizer release from the substrate can be further reduced without decreasing storability of the fertilizer by using of a particle composition having between at least three or more polymer coatings surrounding and at least one layer of a water-soluable material. In one group of embodiments, the polymer layers and the water-insoluble layers are alternating layers. It was found that these water-insoluble coatings were effective even when they amounted to less than 4.0 percent of the fertilizer particles.

It has been found that the coatings of the present invention provide an efficient way to distribute the fertilizer with less soluble fertilizer components to provide for prolonged effectiveness. It is also possible to provide a dye to the coatings to provide an indicator of the duration of the fertilizer into the soil.

The present invention provides a more economical fertilizer material since it can be produced using a smaller amounts of coating materials while providing the same or better controlled-release of the fertilizer.

The above description of the invention has been directed in part primarily to the utilization of a fertilizer, such as granular urea, carrying amino groups as the nucleophilic functional group. It will be apparent, however, that the same considerations apply when the fertilizer carries different nucleophilic functional groups. The invention has also been described primarily in reference to using a polyisocyanate as the coupling agent. It will again be understood that the same considerations apply when using coupling agents having other or a combination of different functional groups. Finally, the invention has been described primarily with reference to the use of a polyol in the formation of the water-insoluble coating or sealing layer. It will again be understood that the same consideration apply when a different water-insoluble coating or sealing layer is utilized.

Finely divided plant nutrients, particularly those chemicals known as micronutrients, may also be used effectively as diluent fillers in the sealing layer and water-insoluble coatings. Some of the micronutrients found to be particularly suitable for inclusion as diluent fillers are oxides and sulfates of zinc, copper, manganese, and iron.

It has been found that the fertilizer particles of this invention can be readily used as a commercial fertilizer in bulk or bagged form. It was further found that the mass of these particles require no conditioning, such as mineral oil or diatomaceous earth, to make them free flowing and storage stable for long periods of time without agglomerating.

A more complete understanding of the invention can be obtained by reference to preferred embodiments of the invention which are illustrated by the following specific examples of the new products and methods of the invention. It will be apparent to those skilled in the art that the examples involve use of some materials and reagents that are commercially available from known sources, e.g., chemical supply houses, so details respecting them need not be given.

The following examples are intended to illustrate, but not to limit, the methods and compositions of the invention. All percentages described herein are by weight, unless otherwise indicated.

### Examples 1-7

Fertilizers compositions were made from the components listed in table I:

| | | Example | Amount of total |
|---|---|---|---|
| | | No. | composition |
| Substrate | −6 + 14 U.S. | 1 | 92.6 wt. % |
| | Standard Mesh | | |
| | Screen Size | | |
| | granular urea | | |
| | −6 + 14 U.S. | 2 | 96.4 wt. % |
| | Standard Mesh | | |
| | Screen Size NPK | | |
| | −6 + 14 U.S. | 3 | 96.4 wt. % |
| | Standard Mesh | | |
| | Screen Size MAP | | |
| | −6 + 14 U.S. | 4 | 96.4 wt. % |
| | Standard Mesh | | |
| | Screen Site | | |
| | Potash | | |
| | −6 + 14 U.S. | 5 | 96.4 wt. % |
| | Standard Mesh | | |
| | Screen Size MOP | | |
| | −6 + 14 U.S. | 6 | 96.4 wt. % |
| | Standard Mesh | | |
| | Screen Size SOP | | |
| | −6 + 14 U.S. | 7 | 96.4 wt. % |
| | Standard Mesh | | |
| | Screen Size | | |
| | Kmag | | |
| Polymer | Aqueous | Sam for | 0.37 wt. % (5.6 wt. % of |
| component: | triethanolamine | all | polymer component) |
| (Catalyst) | (TEOA) catalyst | examples | |
| | composition | | |
| | (Sigma-Aldrich): | | |
| Polymer | polymeric | Same for | 3.01 wt. % |
| component: | diphenyl methane | all | (44.5 wt. % |
| Cross- | diisocyanate | examples | of polymer |
| linking | (pMDI) | | component) |
| agent | composition: | | |
| | 65% | | |
| | diphenylmethane | | |
| | diisocyanate | | |
| | (MDI) and 35% | | |
| | higher oligomers | | |
| | of MDI with an | | |
| | average molecular | | |
| | weight of 350, | | |
| | isocyanate (NCO) | | |
| | functional group | | |
| | concentration of | | |
| | 31.9%, specific | | |
| | gravity of 1.24, | | |
| | kinematic | | |
| | viscosity at 25° C. | | |
| | of 80 centipoise | | |
| Polymer | Terate polyol | Same for | 3.37 wt % (49.9 wt. % of |
| component: | composition: | all | polymer component) |
| Monomer- | Terate HT 5500 | examples | |
| polyol | (Invista); Water | | |
| | less than 1.5%, | | |
| | hydroxyl number | | |
| | of 225-245 | | |
| Water- | C30+ alpha olefin | Same for | 0.68 wt. % although this |
| insoluble | wax | all | amount can be varied |
| material | | examples | |

The samples were prepared by one of methods as follows.

### Process Example 1

To a laboratory rotary drum coater, 3 kg −6+14 U.S. Standard Mesh Screen Size granular fertilizer particles were added and rotation of the drum at a constant drum speed of 15-16 rpm and heating at 70-75° C. was initiated which is above the melting point of the terate polyol composition but below 100° C. to provide a cascading flow of the fertilizer composition. A base coating surrounding and bonded to the fertilizer was formed by injecting 33.6 g pMDI (Mondur 541 Light by Bayer) composition over about 1 minute onto the top layer of the fertilizer composition. There was sufficient polymeric diphenylmethane diisocyanate so that all of the NCO functional groups were not reacted by the reactive groups at the surface of the fertilizer granules while forming the base coating. Simultaneous with or subsequent the previous step the 36.4 g terate polyol composition (containing 10% TEOA catalyst) was injected onto the top layer of the fertilizer composition and the heat was maintained to ca. 60-70° C. over about 1 minute. The pMDI and terate polyol compositions were then allowed to react to form a solidified polyurethane coating on the fertilizer substrate (about 5 min.). The above coating steps were repeated 2 times. Then 21 g. of a C30+ alpha-olefin wax (CP Chem) composition was added and rotated for about 5 min. to produce an outer wax coating. The product composition was cooled with continuous agitation to about 45° C. such that the temperature of the product is below the melting point of the wax. The product was emptied out of the drum and cooled further to room temperature.

### Process Example 2

To a laboratory rotary drum coater, 1 kg −6+14 U.S. Standard Mesh Screen Size granular fertilizer particles were added and rotation of the drum at a constant drum speed of 15-16 rpm and heating at 70-75° C. was initiated which is above the melting point of the terate polyol composition but below 100° C. to provide a cascading flow of the fertilizer composition. A base coating surrounding and bonded to the fertilizer was formed by injecting 8.13 g pMDI (Mondur 541 Light by Bayer) composition over about 1 minute onto the top layer of the fertilizer composition. There was sufficient polymeric diphenylmethane diisocyanate so that all of the NCO functional groups were not reacted by the reactive groups at the surface of the fertilizer granules while forming the base coating. Simultaneous with or subsequent the previous step the 10.13 g terate polyol composition (containing 10% TEOA) was injected onto the top layer of the fertilizer composition and the heat was maintained to ca. 60-70° C. over about 1 minute. The pMDI and terate polyol compositions were then allowed to react to form a solidified polyurethane coating on the fertilizer substrate (about 5 min.). Then 1.83 g. of a C30+ alpha-olefin wax (CP Chem) composition was added and rotated for about 5 min. to produce a wax coating. The above coating steps were repeated 3 times. The product composition was cooled with continuous agitation to about 45° C. such that the temperature of the product is below the melting point of the wax. The product was emptied out of the drum and cooled further to room temperature.

### Process Example 3

To a laboratory rotary drum coater, 2 kg −6+14 U.S. Standard Mesh Screen Size granular fertilizer particles were added and rotation of the drum at a constant drum speed of 15-16 rpm and heating at 70-76° C. was initiated which is above the melting point of the terate polyol composition but below 100° C. to provide a cascading flow of the fertilizer composition. A base coating surrounding and bonded to the fertilizer was formed by injecting 11.61 g pMDI (Mondur 541 Light by Bayer) composition over about 3 minute onto the top layer of the fertilizer composition. There was sufficient polymeric diphenylmethane diisocyanate so that all of the NCO functional groups were not reacted by the reactive groups at the surface of the fertilizer granules while forming the base coating. Then 14.51 g terate polyol composition (containing 10% TEOA catalyst) was injected onto the top layer of the fertilizer composition and the heat was maintained to ca. 74° C.±2° C. over about 1 minute. The pMDI and terate polyol compositions were then allowed to react to form a solidified polyurethane coating on the fertilizer substrate (about 5 min.). Then 2.75 g. of a C30+ alpha-olefin wax (CP Chem) composition was added and rotated for about 5 min. to produce a wax coating. The above coating steps were repeated 3 times. An outer coating surrounding and bonded to the fertilizer was formed by injecting 2.45 g pMDI (Mondur 541 Light by Bayer) composition over about 1 minute onto the top layer of the fertilizer composition. Simultaneous with or subsequent the previous step the 3.06 g terate polyol composition (containing 10% TEOA was injected onto the top layer of the fertilizer composition and the heat was maintained to ca. 70-76° C. over about 1 minute. The pMDI and terate polyol compositions were then allowed to react to form a solidified polyurethane coating on the fertilizer substrate (about 5 min.). The product was emptied out of the drum and cooled further to room temperature.

### Example 5

### Storage, Dissolution Testing

The Water release rate profile for the controlled release fertilizer material was then determined using the following procedure. 10 grams of the sample was weighed into a bottle and 100 mL of deionized water was added and the bottle was capped. The sample was allowed to stand for a specified time at a constant temperature (typically at room temperature). The bottle was gently swirled to mix the solution and an aliquot of the solution was taken to determine the refractive index using a Bellingham-Stanley refractometer (model RFM340) at 25° C. The last step was repeated for a specified number of days.

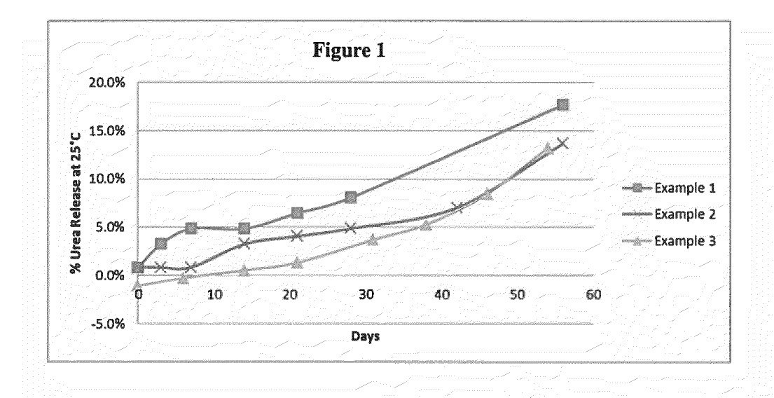

The Water release rate profiles for the controlled release fertilizer material produced in Examples 1-3 are illustrated in FIG. 1. As shown in FIG. 1, the water release rate profile for the material produced in Examples 1-3 are significantly better than that for uncoated urea and results in materials with a release profile of nitrogen extending over several months. Further, this was achieved using significantly less coating in Example 4 (5.5 weight percent of coating based on the weight of the substrate) compared with Example 2 (7.3 weight percent of coating based on the weight of the substrate).

In the above examples illustrating the present invention, the water-soluble substrate can be replaced by other fertilizers containing materials including ureaform, alkylurea, biurets, guanidine, melamine, amino acids, proteins, methanol ureas, ethanolamines, ammonia compounds, nitrogen-containing polyols, monoammonium phosphate, diammonium phosphate, ammonium polyphosphate, monopotassium phosphate, dipotassium phosphate, potassium bicarbonate, ammonium sulfate, potassium bisulfate, potassium formate, potassium acetate, potassium diacetate, and a material containing elemental sulfur. Additionally, the coupling agent can be replaced by terephthalic acid, adipic acid, maleic anhydride, methyl terephthalic acid, or a prepolymer of a polyisocyanate and polyol. The water-insoluble sealing layer which surrounds and chemically bonds to the base coating can be based on caprolactam, epichlorohydrin, propylene oxide, ethylene oxide, styrene oxide, hexamethylene tetramine, and natural and synthetic polysaccharides; as well as prepolymers containing unreacted epoxy groups, or phenol formaldehyde polymers carrying functionality reactive with the selected coupling agent.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A solid fertilizer composition comprising:
(a) at least one plant fertilizer compound in solid form;
(b) at least 3 layers of a polyurethane coating which is a reaction product of:
i: a polyisocyanate, and
ii: a polyol; and
(c) a coating comprising a wax.

2. The solid fertilizer composition of claim 1, wherein one of the polyurethane layers is in closest contact with the fertilizer compound is chemically bonded to the fertilizer compound.

3. The solid fertilizer composition of claim 1, wherein at least one wax layer is the outer layer.

4. The solid fertilizer composition of claim 1, wherein at least one wax layer is between two of the polyurethane layers.

5. The solid fertilizer composition of claim 1, having three polyurethane layers.

6. The solid fertilizer composition of claim 1, having four polyurethane layers.

7. The solid fertilizer composition of claim 1, wherein the polyurethane layer is chemically bonded to the fertilizer compound.

8. The solid fertilizer composition of claim 1, wherein the fertilizer compound is urea.

9. A process of producing a fertilizer of claim 1 comprising:
(a) providing a substrate of plant food compound;
(b) optionally prewetting said plant fertilizer compound with a prewetting solution comprising water and a catalyst;
(c) rotating said substrate product of step (b);
(d) contacting product of step (c) above with a polyisocyanate; and
(e) contacting said product of step (d) with a polyol;
(f) allowing the polyisocyanate and polyol to react forming a solidified polyurethane coating on said fertilizer particles,
(g) repeating step (a) at least 3 times;
(h) adding to said product of step (g) an organic wax to produce a wax coating thereon, and
(i) thereafter cooling said coated fertilizer particles to below the melting point of the wax.

10. The composition made by the method of claim 4.

11. A granular coated fertilizer according to claim 1, wherein at least one of the first polymer and the second polymer is urethane polymer.

12. A granular coated fertilizer according to claim 1, wherein the water-insoluble material is a wax.

13. A granular coated fertilizer according to claim 1, wherein the amounts of the fertilizer to polymer and water-insoluble material is from about 90-97:2.5-6:0.1-1 part by weight respectively based on 100 parts by weight of the granular fertilizer.

14. A composition of claim 11, wherein the composition in a granule, a prill, a pellet, a pastille, or a compounded form.

15. A composition of claim 16, wherein the composition is a granule.

16. The use of the composition of any one of the preceding claims in agricultural applications wherein the function of a nitrification inhibitor is desired.
